(19) United States
(12) Patent Application Publication
(10) Pub. No.: US 2014/0320634 A1
(43) Pub. Date: Oct. 30, 2014

(54) CLEANING SYSTEM FOR PINHOLE CAMERA

(71) Applicant: PROCEMEX OY, Jyväskylä (FI)

(72) Inventor: Jorma LYYRA, Kuopio (FI)

(73) Assignee: PROCEMEX OY, Jyväskylä (FI)

(21) Appl. No.: 14/258,403

(22) Filed: Apr. 22, 2014

(30) Foreign Application Priority Data
Apr. 22, 2013 (FI) 20135407

(51) Int. Cl. H04N 5/225

(52) U.S. Cl. CPC H04N 5/2251
USPC 348/88

(57) ABSTRACT

The invention relates to a web monitoring beam including at least one camera placed therein and being equipped with a camera lens cleaning system with means for generating compressed air. The camera placed inside the web monitoring beam is a pinhole camera with a chamber area between the lens and the pinhole of the pinhole camera. Compressed air is blown into the chamber area, which compressed air exits via the pinhole of the pinhole camera, removing the impurities from the chamber area. The invention also relates to a pinhole camera including a cleaning system.

### FIELD OF THE INVENTION

The present invention relates to a device for cleaning and maintaining the cleanliness of lenses in cameras used for web monitoring and/or detecting defects in web-like products, for example in paper and cardboard machines, as well as a beam that comprises cameras, and a device for cleaning and maintaining the cleanliness of camera lenses.

### BACKGROUND OF THE INVENTION

In paper and cardboard machines, a web-like material running through the machine, such as paper or cardboard, is continuously formed. In paper machines, the web must be controlled in order to detect possible defects in the paper or cardboard web and to obtain a final product of high quality. Generally, cameras of web monitoring camera systems for detecting web breaks are installed inside various beams or beam structures extending above the web. Above the web, the cameras monitor the quality of the web, for example through openings or windows in the beams or beam structures. However, the quality of an image produced by a camera belonging to a web monitoring camera system placed in the beam structure may be affected by splashes blurring the observation windows or the camera lenses in the paper or cardboard machines. The soiling hampers the detecting of defects in the web. However, it has to be possible to secure the quality of the web to meet the clients' strict quality specifications.

These days, it is therefore necessary to manually wash the camera lenses or the lens protecting structures, such as transparent shields, in the beams and beam systems when they are soiled, so that the soiling would not decrease the quality of the image material produced by the cameras. Similarly, the cleaning of lens protection structures by blowing compressed air or compressed gas is possible in addition to or instead of washing. In blowing, the compressed air/gas is directed past the lens protection structures in such a way that the impurities are removed by the flow of compressed air/gas along the lens or the structures, enabling a higher quality of imaging.

### BRIEF SUMMARY OF THE INVENTION

It is an aim of the present invention to provide a solution to overcome the above-mentioned drawbacks of cameras in web monitoring systems and to present a novel cleaning system for web monitoring cameras in a web monitoring beam. The web monitoring cameras according to the invention are characterized in what will be presented in the independent claims, and the dependent claims relate to advantageous embodiments of the invention.

The invention is based on the idea that the web monitoring beam comprises one or more pinhole cameras, with a chamber area formed between the lenses and the walls forming the pinhole. Compressed air is blown into these chamber areas in such a way that impurities accumulated in front of the lens in the chamber area are blown with the compressed air through the pinhole out of the chamber area.

The invention relates to a web monitoring beam comprising at least one camera placed inside the web monitoring beam and equipped with a camera lens cleaning system comprising means for generating compressed air. The camera placed inside the web monitoring beam is a pinhole camera which comprises a chamber area between the lens and the pinhole of the pinhole camera. The chamber area is equipped with an orifice for blowing compressed air into the chamber area, and the compressed air is arranged to exit the chamber area via the pinhole of the pinhole camera.

In an advantageous embodiment, the chamber area of the pinhole camera is formed between the lens and the pinhole of the pinhole camera by means of a flange. In an advantageous embodiment, the means for generating compressed air comprise a compressed-air tank, at least one hose, and a nozzle for compressed air, connected to the orifice of the chamber area and configured to blow compressed air from the compressed-air tank via the hose into the chamber area.

The invention also relates to a pinhole camera comprising a lens cleaning system. The pinhole camera comprises a chamber area formed between the lens of the pinhole camera and the orifice of the pinhole camera and equipped with an orifice for blowing compressed air into the chamber area. From the chamber area, the compressed area is configured to exit via the pinhole of the pinhole camera.

In an advantageous embodiment, the chamber area is formed between the lens and the pinhole of the pinhole camera by means of a flange. In an advantageous embodiment, the lens cleaning system of the pinhole camera also comprises means for generating compressed air into the chamber area. In an advantageous embodiment, the means for generating compressed air comprise a compressed-air tank, a hose, and a compressed air nozzle connected to the orifice of the chamber area and configured to blow compressed air from the compressed-air tank via the hose into the chamber area. In an advantageous embodiment, the pinhole camera is configured to be used in a web monitoring beam.

### DESCRIPTION OF THE DRAWINGS

In the following, the present invention will be described in more detail with reference to the appended drawings, in which

FIG. 1 shows a cleaning system according to an advantageous embodiment of the invention in connection with one camera in a web monitoring beam, and

FIG. 2 shows a web monitoring beam according to an embodiment of the invention, comprising a camera cleaning system according to the invention.

### DETAILED DESCRIPTION OF THE INVENTION

Due to competition, paper and cardboard machines have to be operated with increasing running speeds and minimized downtimes, and have to produce a high-quality product meeting strict quality specifications. Improving productivity is an aim in production as well as in maintenance, and achieving this aim is enhanced by various cleaning systems for web monitoring systems and cameras. For example, a compressed-air nozzle may be integrated in a web monitoring beam, for blowing compressed air into the beam at the first end of the beam, the air being guided out at the second end of the beam. The aim is to guide dust or other impurities entered in the beam by means of compressed air out of the beam, via the end of the beam. In this method, the whole beam is filled with compressed air. However, the length of the beam may be so great that the required air pressure becomes relatively high, in order to secure a sufficient pressure for removing dust and/or impurities from the inside of the beam.

In the system for cleaning or maintaining the cleanliness according to the invention, integrated in cameras in the web monitoring beam and in the camera system for detecting web breaks in the web monitoring beam, a so-called chamber area is provided in connection with each lens of the camera, to which compressed air is guided by means of a compressed-air nozzle. The chamber area may be provided around the lens by means of e.g. a flange. Because the cameras in the web monitoring beam according to the invention and the cameras according to the invention are preferably pinhole cameras, the pinhole of the camera is used as an outlet for compressed air. Consequently, in the solution according to the invention, an area is formed by e.g. a flange between the camera lens and the wall comprising the pinhole of the camera, into which area compressed air is blown and from which area the compressed air exits via the pinhole of the camera, entraining any dust, splashes, chemicals, water, or other material possibly entered in the chamber area, through the pinhole of the camera. With the structure according to the invention, there is no need to supply a large volume (e.g. the whole beam) with compressed air, but compressed air can be supplied into each chamber area of the camera from a compressed-air tank by means of a hose or the like. The volume of the chamber area is considerably smaller than that of the beam, so that the quantity of compressed air needed for cleaning will remain significantly smaller with chamber structures according to the invention, integrated in cameras, than when the whole beam is supplied with compressed air.

The term “web monitoring beam” refers to any beam or beam structure that can be used for web monitoring; in other words, the beam can be placed in the vicinity of the web in a transverse direction with respect to the web, to support at least one functional device used for web monitoring, for example a camera. With respect to its length, shape or material, the beam is not limited in any way but it can be e.g. a beam structure made of carbon fibre material and consisting of several modules, or it can be a solid beam made of carbon fibre or metal. Moreover, the placement of the web monitoring beam in a paper or cardboard machine, or in another machine suitable for use of the invention, is not limited. However, it is possible that the greatest benefit of the cleaning system according to the invention, integrated in cameras, is obtained by placing the cameras in a location having a high degree and/or rate of contamination of the cameras, for example in the vicinity of the head-box of the paper or cardboard machine, on top of the top wire or underneath the paper or cardboard web.

Consequently, the invention is not limited solely to the web monitoring beam comprising cameras according to the invention, but the invention also relates to single cameras according to the invention which can be placed in a web monitoring beam.

Thus, the cameras according to the invention that are placed in a web monitoring beam according to the invention, are preferably pinhole cameras. The pinhole cameras are not limited with respect to their type or model, or the size of the pinhole, but they can be selected according to the object and the location to be monitored and the need for monitoring, and they can be any pinhole cameras in which a chamber area can be provided around the lens and supplied with compressed air conveyed via a compressed-air nozzle by a hose from a compressed-air tank. In this context, the term “hose” refers to any tube or the like for conveying/transferring compressed air from a compressed-air tank, to be blown into the chamber areas of the pinhole cameras. The number of cameras used in the beam is not limited, but one or more cameras can be provided, and compressed air can be supplied to the chamber areas of all the cameras in the beam. The compressed air is supplied from the compressed-air tank by means of hoses extending inside the beam to the vicinity of the cameras inside the beam, and blown to the chamber area by a compressed-air nozzle. The number of the cameras and thereby also the number of chamber areas and compressed air nozzles may depend on e.g. the length of the beam and on the web to be monitored.

The compressed air used for cleaning can be compressed air or another gas mixture suitable for the purpose. The pressure of the compressed air can be selected according to the use; in other words, the pressure can be higher in an application which comprises several cameras or where the material to be cleaned is heavier than dust, for example splashes. The pressure applied can vary between, for example, 2 and 6 bar.

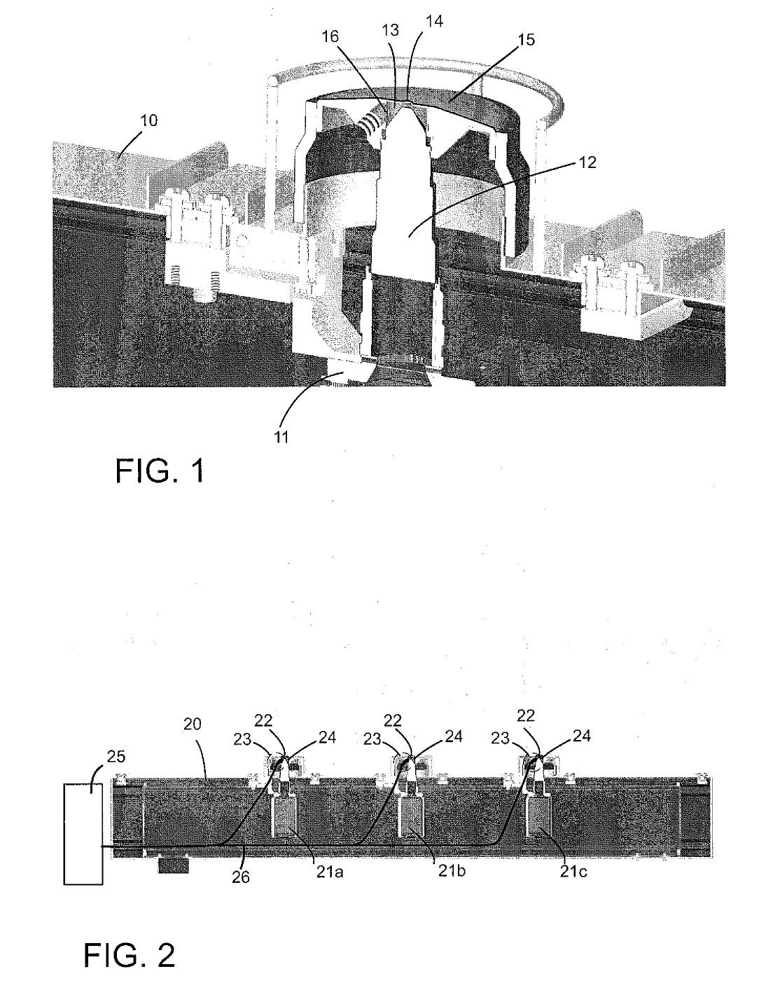

FIG. 1 shows a cross-sectional view of a cleaning system according to an embodiment of the invention in connection with one camera of a web monitoring beam 10. In the cleaning system, a chamber area 13 is provided around the lens 12 of a pinhole camera 11 by a flange, for example a flange made of metal, plastic, Teflon, or a composite. The chamber area 13 is limited by the flange between the lens 12 and the wall comprising the pinhole 14 of the pinhole camera 11, i.e. the lid 15, so that the lower edge of the flange is limited to the lens 12 and the upper edge to the wall 15 on top of the camera lens 12. The flange is arranged tightly between the lens 12 and the wall 15 so that compressed air cannot enter the beam 10 from the joint between the flange and the lens 12 nor from the joint between the flange and the wall 15. The flange limiting the chamber area 13 is equipped with an orifice 16 for a compressed-air nozzle. Compressed air is introduced/blown via the nozzle to the chamber area 13, from which the compressed air exits via the pinhole 14, entraining any impurities accumulated in front or in the vicinity of the lens 12 of the pinhole camera 11, as well as elsewhere in the chamber area, via the pinhole 14. To put it simply, the compressed air is blown by the nozzle via the orifice 16 in the chamber area 13 to the chamber area 13 and further via the pinhole 14 out of the pinhole camera 11 and the beam 10. The compressed-air nozzle is fastened to the orifice 16 in such a way that all air blown from the compressed-air nozzle enters the chamber area 13 and not, for example, inside the beam 10.

FIG. 2 shows a web monitoring beam 20 with pinhole cameras 21a-21c, comprising a cleaning system for the cameras according to an embodiment of the invention. In the cleaning system, the pinhole cameras 21a-21c inside the web monitoring beam 20 are equipped with chamber areas 22, into which compressed air is blown by compressed-air nozzles 23, discharged from the chamber areas 22 via pinholes 24 of the pinhole cameras 21a-21c. The compressed air is supplied from a compressed-air tank 25 by a hose 26 to be blown to the chamber areas 22 inside the beam 20. The hose 26 is connected to the compressed air tank 25. The hose 26 connected to the compressed-air tank 26 is branched so that compressed air can be blown to the chamber areas 22 of the cameras 21a-21c by means of the compressed-air nozzle 23 via an orifice (not shown) in the chamber area 22. However, it is possible to supply compressed air by separate hoses from the compressed-air tank 25 to the chamber areas 22 of each camera 21a-21c.

The present invention is not limited solely to the above-presented examples, but it can be modified within the scope of the appended claims.

1. A web monitoring beam comprising at least one camera placed inside the web monitoring beam and comprising a cleaning system for the lens of the camera, the cleaning system comprising means for generating compressed air, wherein said at least one camera is a pinhole camera that comprises a chamber area formed between the lens and the pinhole of the pinhole camera and provided with an orifice for blowing compressed air into the chamber area, the compressed air being configured to exit the chamber area via the pinhole of the pinhole camera.

2. The web monitoring beam according to claim 1, wherein the chamber area of the pinhole camera is formed between the lens and the pinhole of the pinhole camera by means of a flange.

3. The web monitoring beam according to claim 1, wherein the means for generating compressed air comprise a compressed-air tank, a hose, and a compressed-air nozzle, the compressed-air nozzle being connected to an orifice in the chamber area and configured to blow compressed air from the compressed-air tank via the hose to the chamber area.

4. A pinhole camera comprising a system for cleaning the lens of the pinhole camera, wherein said at least one pinhole camera comprises a chamber area formed between the lens of the pinhole camera and the pinhole of the pinhole camera and provided with an orifice for blowing compressed air into the chamber area, the compressed air being configured to exit the chamber area via the pinhole of the pinhole camera.

5. The pinhole camera according to claim 4, wherein the chamber area is formed between the lens and the pinhole of the pinhole camera by means of a flange.

6. The pinhole camera according to claim 4, wherein the system for cleaning the lens of the pinhole camera further comprises means for generating compressed air in the chamber area.

7. The pinhole camera according to claim 6, wherein the means for generating compressed air comprise a compressed-air tank, a hose, and a compressed-air nozzle, the compressed-air nozzle being connected to an orifice in the chamber area and configured to blow compressed air from the compressed-air tank via the hose to the chamber area.

8. The pinhole camera according to claim 4, wherein the pinhole camera is configured to be used in a web monitoring beam.
